(19) United States
(12) Patent Application Publication
(10) Pub. No.: US 2014/0022510 A1
(43) Pub. Date: Jan. 23, 2014

(54) Image engine and projection system with two discrete format channels

(71) Applicants: Bernhard Rudolf Bausenwein, Hagelstadt (DE); Max Mayer, Forchheim (DE)

(72) Inventors: Bernhard Rudolf Bausenwein, Hagelstadt (DE); Max Mayer, Forchheim (DE)

(21) Appl. No.: 13/507,663

(22) Filed: Jul. 18, 2012

(51) Int. Cl. G02B 27/26; G03B 21/28; G03B 21/14

(52) U.S. Cl. 353/8; 353/34; 353/20; 353/121

(57) ABSTRACT

An image engine and a projection system with two discrete format channels are described. The engine comprises a spatial light modulating system in each channel and a combining layer. A specific arrangement of the modulators of the two spatial light modulating systems relative to the combining layer makes it possible that one modulating system generates a landscape format image while the second modulating system generates a portrait format image in a common output path. In the projection system, a control logic addresses either the landscape channel or the portrait format channel or both channels, depending either on the format of the incoming image data, or on external controls.

### BACKGROUND OF THE INVENTION

In ancient times of imaging and image reproduction, there was complete freedom of the formats. A painter is free to choose any format he can possibly handle. With fotography, that freedom was reduced by the available formats of plates and later films, and besides the quadratic format of large-format cameras the smaller rectangular format of the 35 mm cameras took over. In digital fotography, the format is determined by the imager. The fotographer can still choose between landscape and portrait format, according to the needs and wants of the fotographer and the picture to be taken. Moreover, the fotographer can crop and resize the picture to use any format he or she likes for the prints.

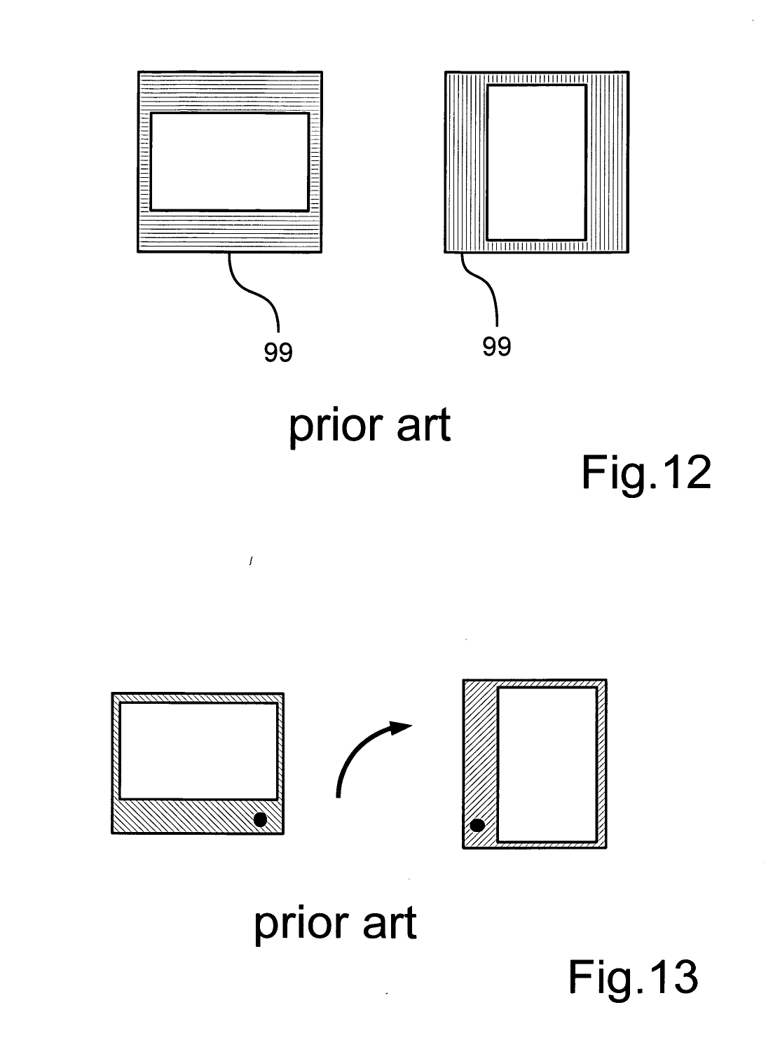

Slide projectors have a quadratically illuminated projection path, and there is a free choice whether a quadratic image or—much more common—a landscape or a portrait format image is to be projected. The format is chosen by the frame of the single slides to be projected (FIG. 12). The frame masks either top and bottom regions (FIG. 12, left side) to present a landscape format, or the same frame, rotated by 90, masks left and right regions (FIG. 12, right side) to leave a portrait format to be projected.

With the advent of the TV, but even more so with cinema formats the landscape format took over. The landscape format is by far dominant over portrait formats in PC monitors. Digital image display is based prevalently on the the landscape format, and digital projection is based exclusively on the landscape format.

This landscape format has one of few fixed width:height ratios. Earlier monitors had a ratio of 5:4 (width:height). These were replaced by the wider 4:3 format, and recently by the even wider 16:10 or 16:9 “wide” landscape formats. A similar development is seen in the formats of spatial light modulators in digital projectors. The tendency is towards the TV-formats and these tend to develop towards the cinematic wide landscape formats.

This is in strong contrast to the needs to project portrait format images in many disciplines and for many purposes. Portraits (faces, busts, whole standing body) need portrait formats. Printed materials (books, letters, handouts) are mostly in the portrait format. Reproduction of these materials should favorably be in portrait format. Many pictures are in the portrait format. Also, there is a trend to use portrait format in advertisement and signage. When portrait format images are displayed on landscape format displays, only a small space of the rectangular modulators, which are aligned horizontally with the projected image, can be used. Accordingly, portrait format images are displayed much smaller than landscape format images, and, correspondingly, with a much lower resolution than the landscape format. Therefore, fixation to just one (the landscape) format is disadvantageous in several aspects. For monitors, there is a solution to portrait format display. While most computer monitors are mounted in the landscape format, some can be mechanically rotated (“pivotted”) by the user into the portrait format (FIG. 13). While larger “signage” monitors cannot be rotated, they can at least be mounted in either the landscape or the portrait format. Here, the portrait format is often seen, especially in advertisement. With the success of recent tablet computers, there has come some new freedom of formats, since these tablets have sensors and switch their display formats according to the wishes of the viewer.

Digital projectors, on the other hand, whether mobile or stationary, are fixed to the landscape format by design and practicability in the state of the art.

### OVERVIEW OF THE INVENTION

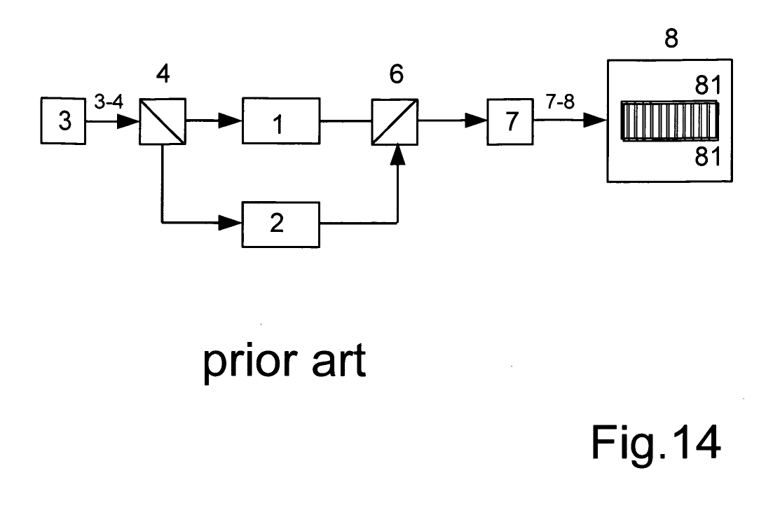

We uncover an image engine and a projection system which use two discrete format channels, usually a landscape format channel and a portrait-format channel. There is a variety of 2-channel systems in the state of the art, which are aiming either to improve the color reproduction (Poradish et al., U.S. Pat. No. 5,612,753; Chen et al, U.S. Pat. No. 7,863,553) or to provide parallel stereoscopic projection (Lee, DE4040081, Fielding, GB2291978; Penn, U.S. Pat. No. 7,324,279, Bausenwein et al., U.S. Pat. No. 7,403,320, U.S. Pat. No. 7,466,473, U.S. Pat. No. 7,817,329). In both cases, perfect overlay of the complete pixel area or overlay of the largest possible area of the modulated spaces is searched (compare FIG. 14).

This is in contrast to our invention, where overlap is not even a required or necessary feature of the disclosure, but may occur and may even be favored for a part of the pixel area.

Depending on the input signal or the controls of the disclosed device, either a landscape-format or a portrait-format image can be projected, or both imagers can be simultaneously active, for a double projection of two images. The system may therefore be capable to project monoscopic and parallel stereoscopic information. The image engine with two discrete format channels comprises a light providing system (3) and two spatial light modulating systems (1,2), each including at least one spatial light modulator, configured to generate a rectangular image, characterized by a pixel array with a larger and a smaller side, and a format combining layer (6). The light of the light providing system is guided by a first and a second illumination path onto the modulators of the first and the second spatial light modulating systems (1,2). The modulated light beams of the first and the second spatial light modulating systems (1,2) are then guided onto the format combining layer (6) along a first and second single format path (1-6, 2-6). The format combining layer (6) is arranged such that it transmits light derived from one of the single format paths, and such that it reflects light derived from the other single format path into the same direction as the transmitting path transmits the layer, and accordingly combines the two single format paths to a dual-format output path (6-7).

Central to the invention is the relative geometric arrangement of the modulators of the first and the second spatial light modulating systems (1,2) with respect to the format combining layer (6). While in most 2-channel image engines according to the state of the art a complete overlap of the pixel arrays of the channels is pursued, in the disclosure we aim to position one spatial light modulating system to relay a landscape format image and to position the second spatial light modulating system to relay a portrait format image. To achieve that, the relative orientation of the spatial light modulating systems (1,2) with the format combining layer (6) is such that the virtual projection of the longer side of the pixel array of the first spatial light modulating system (1) along the first single format path (1-6) onto the format combining layer (6) is parallel to the virtual projection of the smaller side of the pixel array of the second spatial light modulating system (2) along the second single format path (2-6) onto the format combining layer (6). Vice versa, the virtual projection of the smaller side of the pixel array of the first spatial light modulating system (1) onto the format combining layer (6) along the first single format path (1-6) is parallel to the virtual projection of the longer side of the pixel array of the second spatial light modulating system (2) onto the format combining layer (6) along the second single format path (2-6).

In many embodiments of the invention, the transmission axis of the modulated beam of the first spatial light modulating system (11) and the reflection axis of the modulated beam of the second spatial light modulating system (23) will not only be parallel, but be identical. In this case, the rectangular pixel arrays of the first and the second modulating systems will be crossed.

The pixel arrays of the first and the second may, and often will be of the same size, e.g. when the same modulators will be used in both channels, but different sizes of the modulators also fit to the scope of the invention. The disclosure does not rely on a specific type of modulator. Transmissive LCD, a reflective LCoS or a reflective MOEMS or any other type of spatial light modulator can be integrated in the light modulating systems according to our invention.

In a special aspect of the invention, the two formats might differ in the output beam in their polarization. In that case, the format combining layer (6) might be a polarizing beam splitting layer. The two formats might also differ in other light properties, e.g. a different set of primary colors.

A projection system based on the image engine with two discrete format channels might further include projection optics (7) and a control system (5). The control system (5) relays the image input data (d) to the spatial light modulating systems (1,2). The control system (5) could be configured to relay monoscopic images either to the landscape or to the portrait format channel, depending on the input image format. The control system could also be configured to relay dual-image information to both channels. Dual-image information could either be two monoscopic images or stereoscopic information. If the first and the second spatial light modulating systems (1,2) were aligned such that they generate overlapping images, which is a preferred arrangement in several aspects of the invention, true parallel stereoscopic images could be displayed in that overlapping area.

The light providing system (3) could comprise either a separate light source for each channel, or it could include a single light source for both channels. In that case, the engine might further include a beam splitter (4) to guide illumination light into the landscape format and/or into the portrait format channel.

If the format combining layer (6) is a polarizing beam splitting layer, the beam splitter (4) might also be a polarizing beam splitter. Optionally, a polarization conversion system could be included upstream of this splitter. If the polarization conversion system would comprise a prepolarizer (33) and a switchable retarder (34), most of the light could either be selectively directed to the landscape or to the portrait format channel.

In a further modification of the invention, an optional switchable polarization retarder (61) could be included downstream of the polarizing beam splitting layer (6). This would allow to switch the polarization of the modulated images and would enable the system to project sequential stereoscopic images in either the landscape or the portrait format. When both the upstream and the downstream polarization switching systems were included, the high light efficiency resulting from using a polarization conversion system in the invention is coupled to a switchable state of polarization. The first and second spatial light modulating systems (1,2) could either comprise a single modulator in each system or several spatial modulators in each system. If there is just one modulator in each system, color information might be delivered sequentially to the modulators. In that case, primary colors could either be supplied by the alternative filtering of white light, be it mechanically or electronically controlled. Sequential color could also be delivered to the modulators derived from several light sources.

The foregoing and other features, aspects and advantages of the present invention will become more apparent from the following detailed description of the present invention when taken with the accompanying drawings.

### LIST OF DESIGNATORS USED IN THE DRAWINGS

1: first spatial light modulating system

1R,1G,1B: Red, green and blue light modulator of (1)

14: prism with total internal reflection surface to separate illumination and modulated beams at a reflective spatial modulator of the first spatial modulating system

15: polarizing beam splitting layer to separate illumination and modulated beams at a reflective spatial modulator of the first spatial modulating system

2: second spatial light modulating system

2R,2G,2B: Red, green and blue light modulator of (2)

24: prism with total internal reflection surface to separate illumination and modulated beams at a reflective spatial modulator of the second spatial modulating system

25: polarizing beam splitting layer to separate illumination and modulated beams at a reflective spatial modulator of the second spatial modulating system

3: light providing system

3R,3R*,3G,3G*,3B,3B*: Red, green and blue light providing systems

31: color wheel

35, 36: color combining system

33: prepolarizing system

34: illumination polarization switcher

4: beam splitter

45,46,47,48: reflection surface

5: control system

6: format combining layer

61: output polarization switcher

7: projection optics

8: image plane

81: landscape format image

82: portrait format image

99: frame mask

d: image data

1-6: first single format path: optical path from the first spatial light modulating system (1) to the format combining layer (6)

2-6: second single format path: optical path from the second spatial light modulating system (2) to the format combining layer (6)

3-1: optical path for the illumination light from the light providing system (3) to the first spatial light modulating system (1)

3-2: optical path for the illumination light from the light providing system (3) to the second spatial light modulating system (2)

3-4: optical path from the light providing system (3) to the beam splitter (4)

4-1: optical path for illumination light from the beam splitter (4) to the first spatial light modulating system (1)

4-2: optical path for illumination light from the beam splitter (4) to the second spatial light modulating system (2)

6-7: optical path from the format combining layer (6) to the projection optics (7)

7-8: optical path from the projection optics (7) to the image plane (8)

5-1: control line from the control system (5) to the first spatial light modulating system (1)

5-2: control line from the control logic (5) to the second spatial light modulating system (2)

5-3: control line from the control logic (5) to the light providing system (3) 5-34: control line from the control system (5) to the illumination polarization switcher (34) 5-61: control line from the control system (5) to the output polarization switcher (61)

### BRIEF DESCRIPTION OF THE DRAWINGS

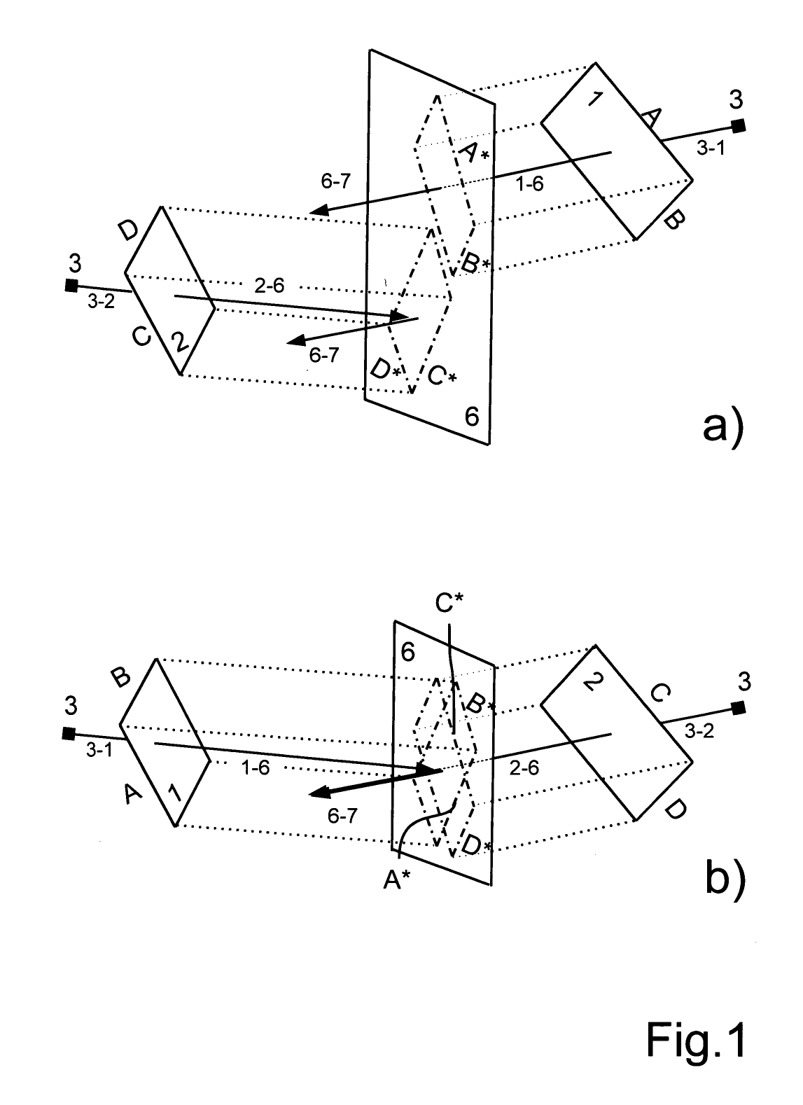

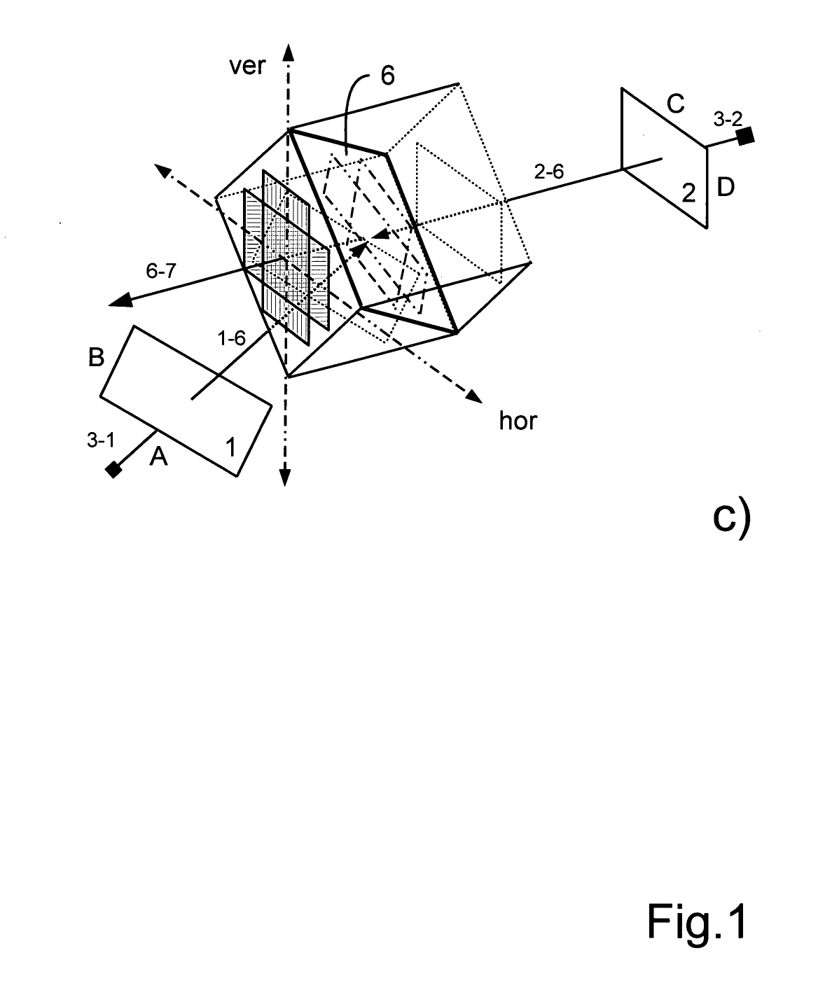

FIG. 1a schematically shows a first image engine with two discrete format channels with non-overlapping virtual projections of the two pixel arrays of the first and of the second spatial light modulating systems (1,2) on the format combining layer (6)

FIG. 1b schematically shows a variant of the engine with overlapping virtual projection of the two pixel arrays of the first and the second spatial light modulating systems (1,2) on the format combining layer (6)

FIG. 1c schematically shows a variant of the engine with an exemplary vertical and horizontal orientation of the landscape- and portrait-formatted images in the output path

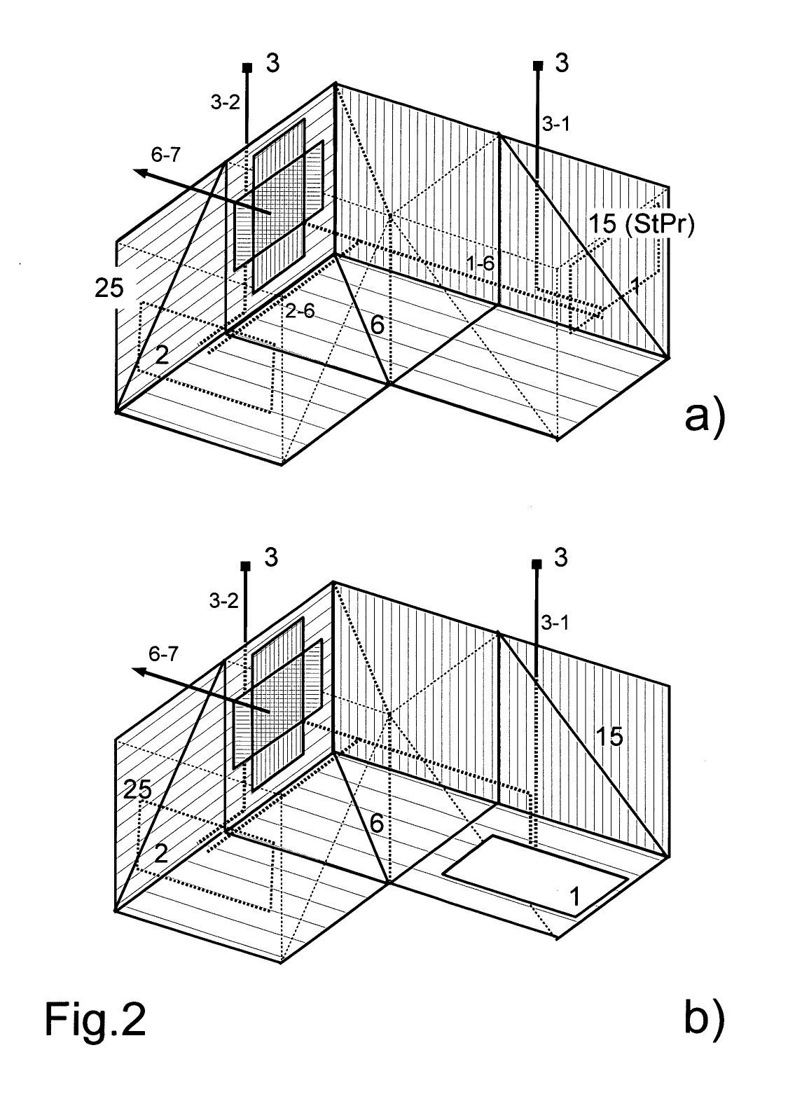

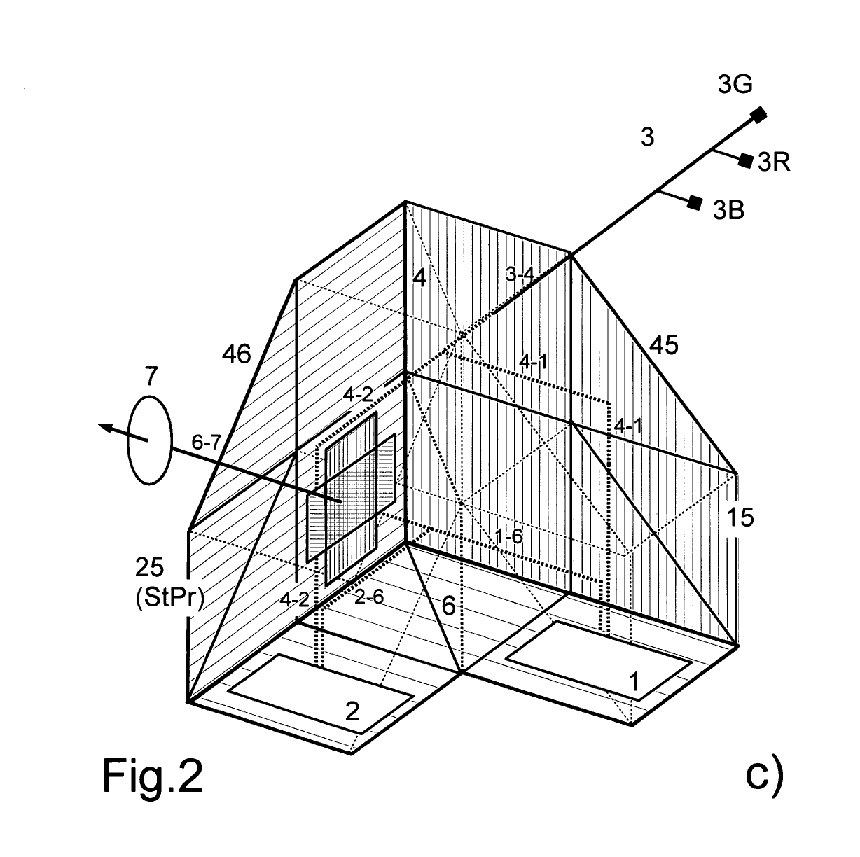

FIG. 2a schematically shows a image engine with two discrete format channels with two reflective LC-displays

FIG. 2b schematically shows a variant of the image engine with two discrete format channels with two reflective LC-displays

FIG. 2c schematically shows a second variant of the image engine with two discrete format channels with two reflective LC-displays

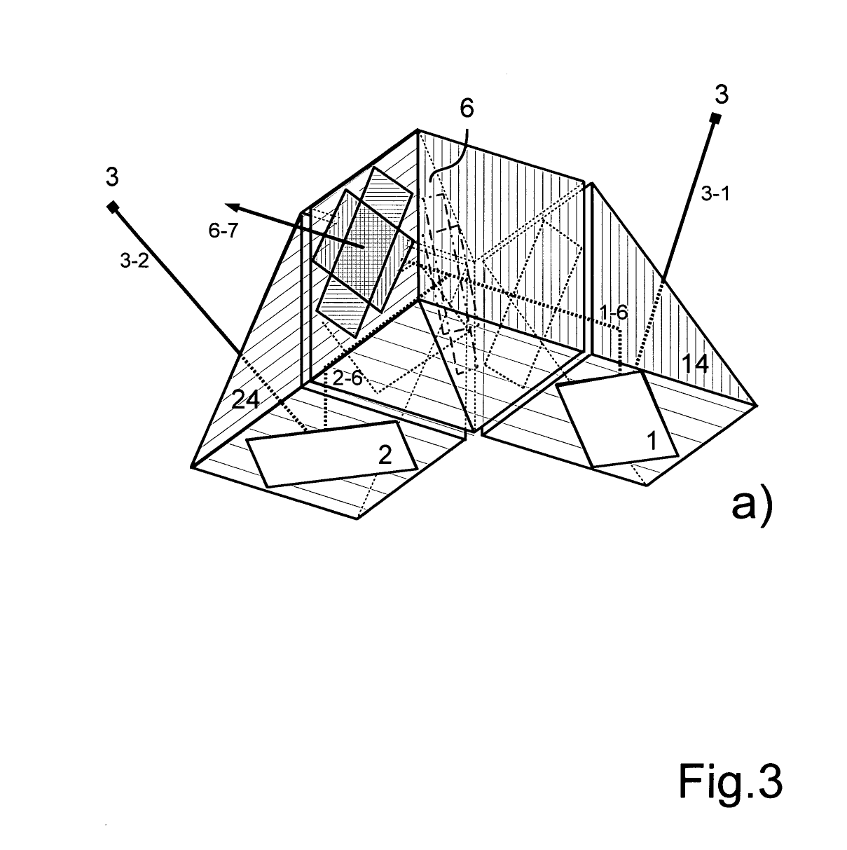

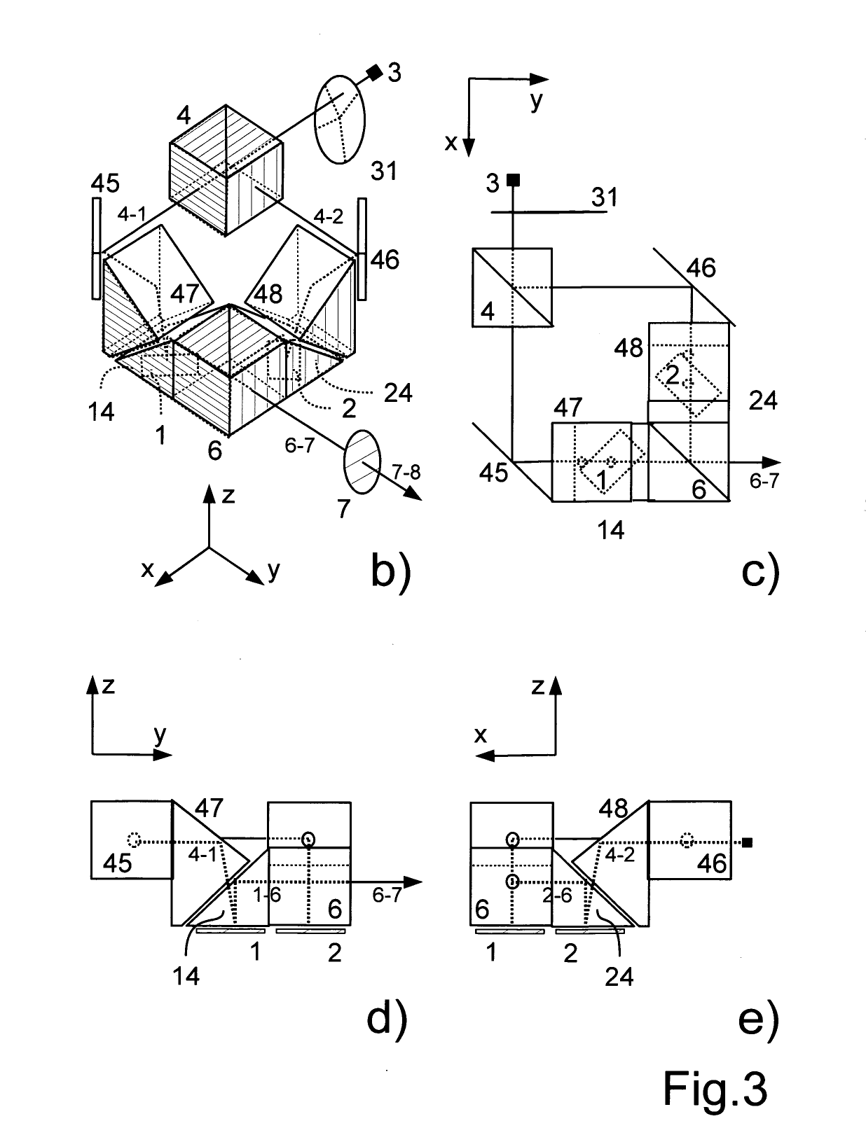

FIG. 3a schematically shows a image engine with two discrete format channels with two reflective MOEMS-displays

FIG. 3b schematically shows a perspective view of a projection system using the image engine shown in FIG. 3a

FIG. 3c schematically shows a top view of a projection system using the image engine shown in FIG. 3a

FIG. 3d schematically shows a side view of a projection system using the image engine shown in FIG. 3a

FIG. 3e schematically shows a second side view of a projection system using the image engine shown in FIG. 3a

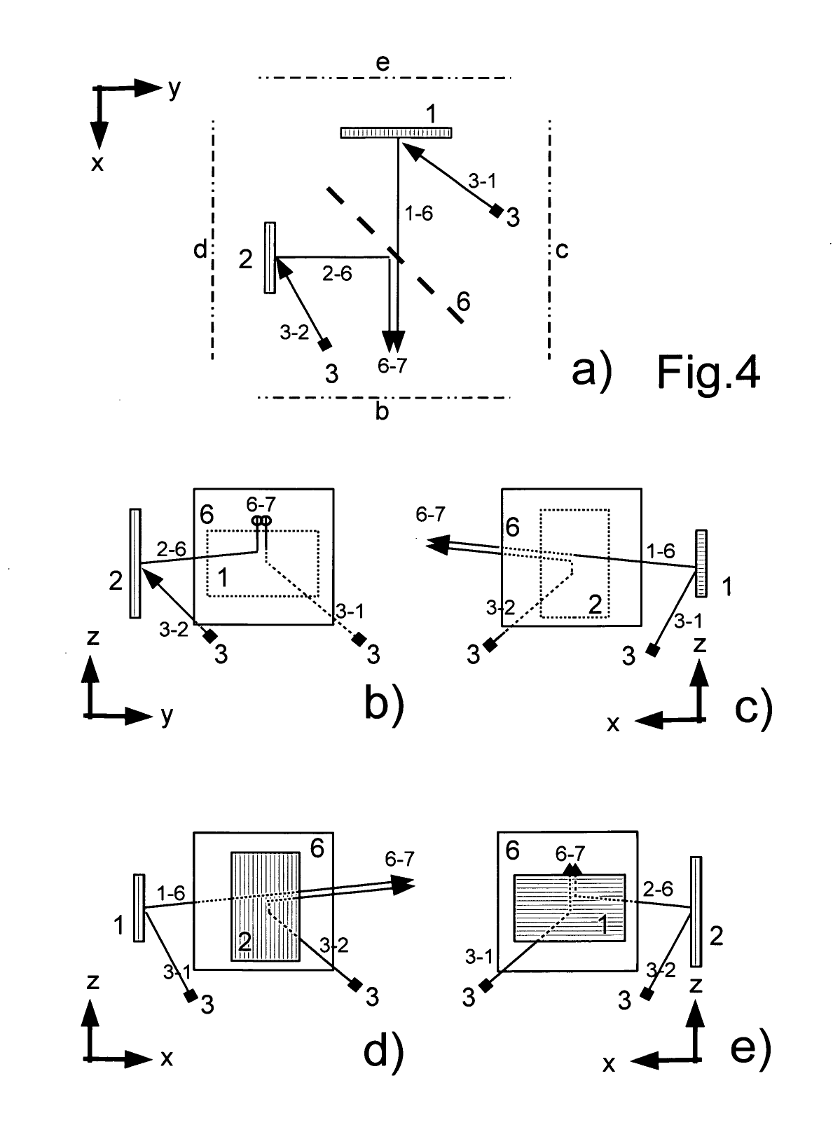

FIG. 4a shows a top view on an image engine with two discrete format channels with 2 MOEMS but without TIR-prisms

FIGS. 4b-e show the four different side views of the system of FIG. 4a

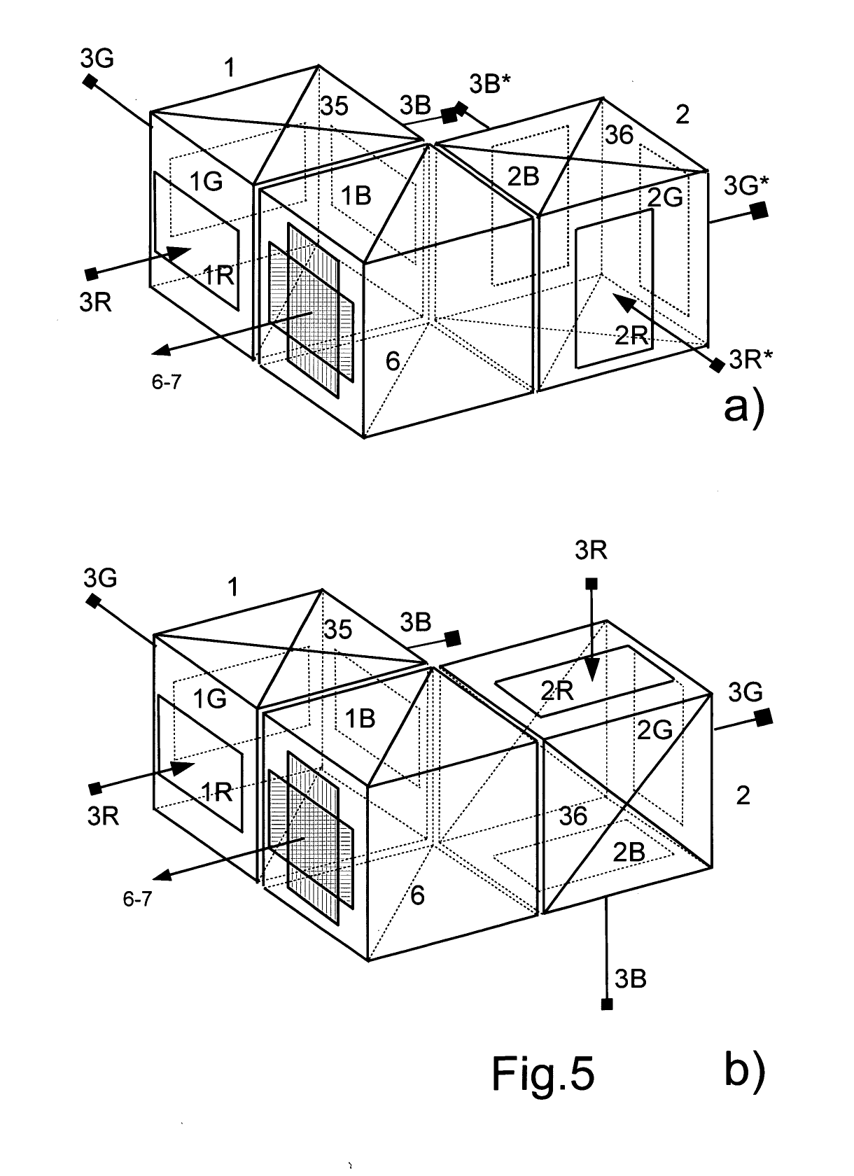

FIG. 5a schematically shows an image engine with two discrete format channels with six transmissive LC-displays

FIG. 5b schematically shows a variant of an image engine with two discrete format channels with six transmissive LC-displays

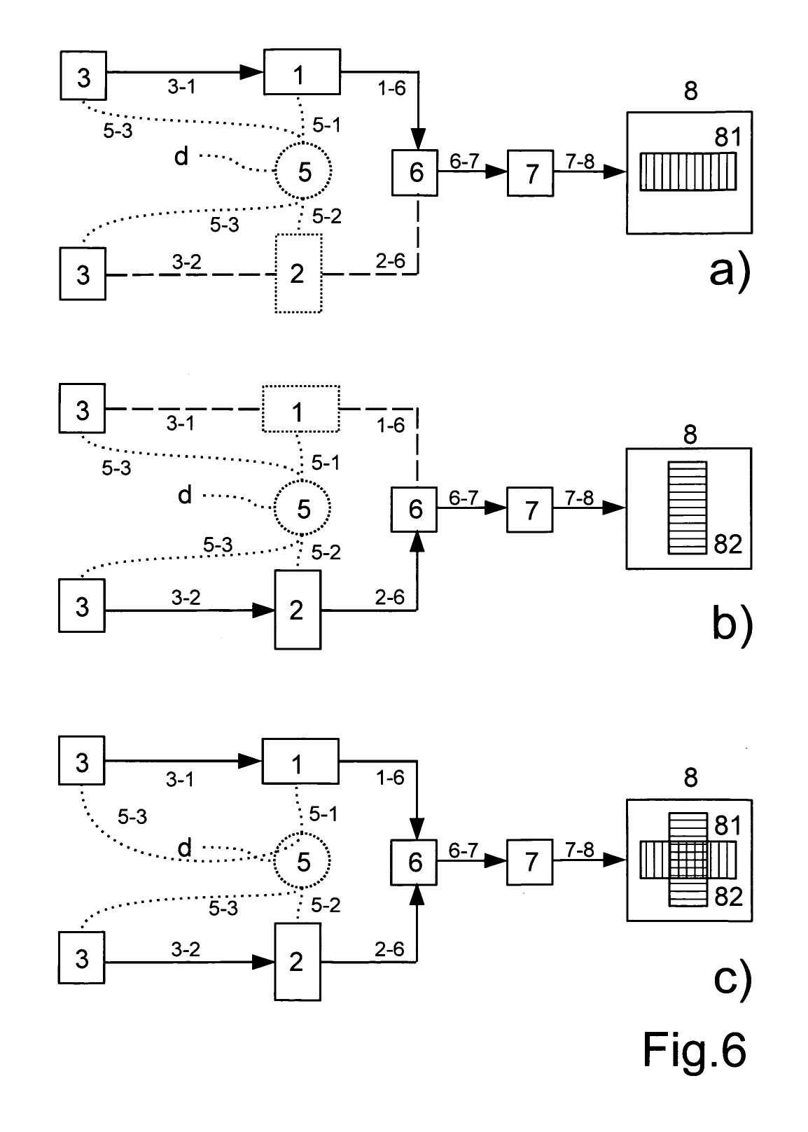

FIG. 6a schematically shows components and light guidance of a projection system with two discrete format channels with the landscape format channel enabled

FIG. 6b schematically shows components and light guidance of a projection system with two discrete format channels with the portrait format channel enabled

FIG. 6c schematically shows components and light guidance of a projection system with two discrete format channels with the landscape and the portrait format channel enabled

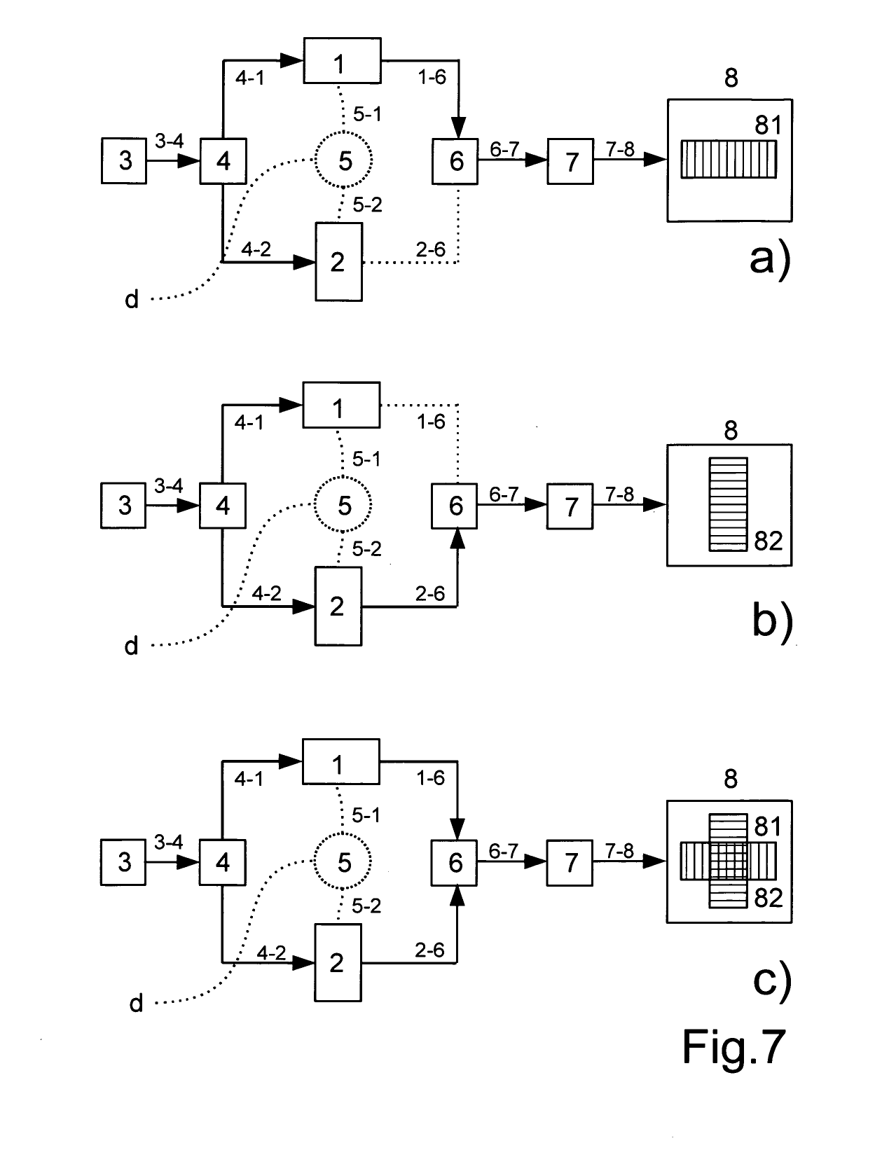

FIG. 7a schematically shows components and light guidance of a projection system with two discrete format channels with the landscape format channel enabled

FIG. 7b schematically shows components and light guidance of a projection system with two discrete format channels with the portrait format channel enabled

FIG. 7c schematically shows components and light guidance of a projection system with two discrete format channels with the landscape and the portrait format channel enabled

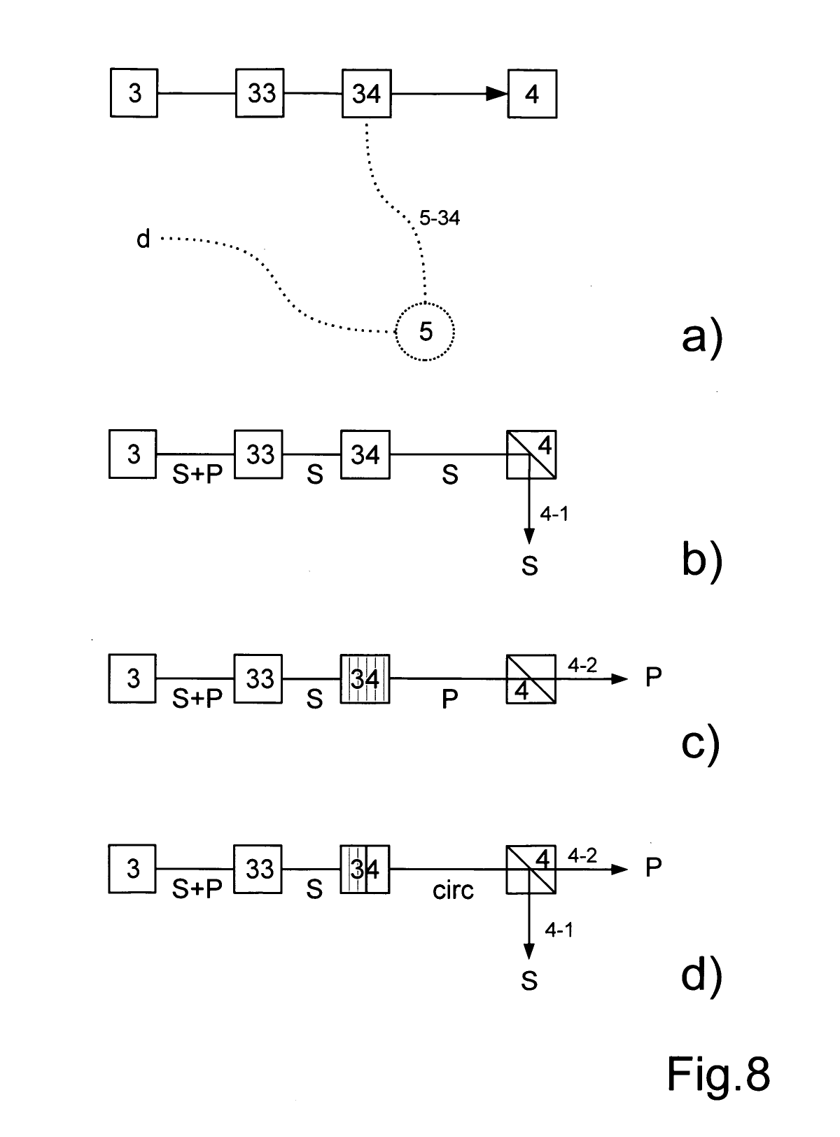

FIG. 8a shows a switchable polarization conversion system upstream of a polarizing beam splitter in a common illumination path

FIG. 8b shows the system of FIG. 8a generating S-polarized light to illuminate just one format channel

FIG. 8c shows the system of FIG. 8a generating P-polarized light to illuminate just one format channel

FIG. 8d shows the system of FIG. 8a generating circular polarized light to illuminate both format channels

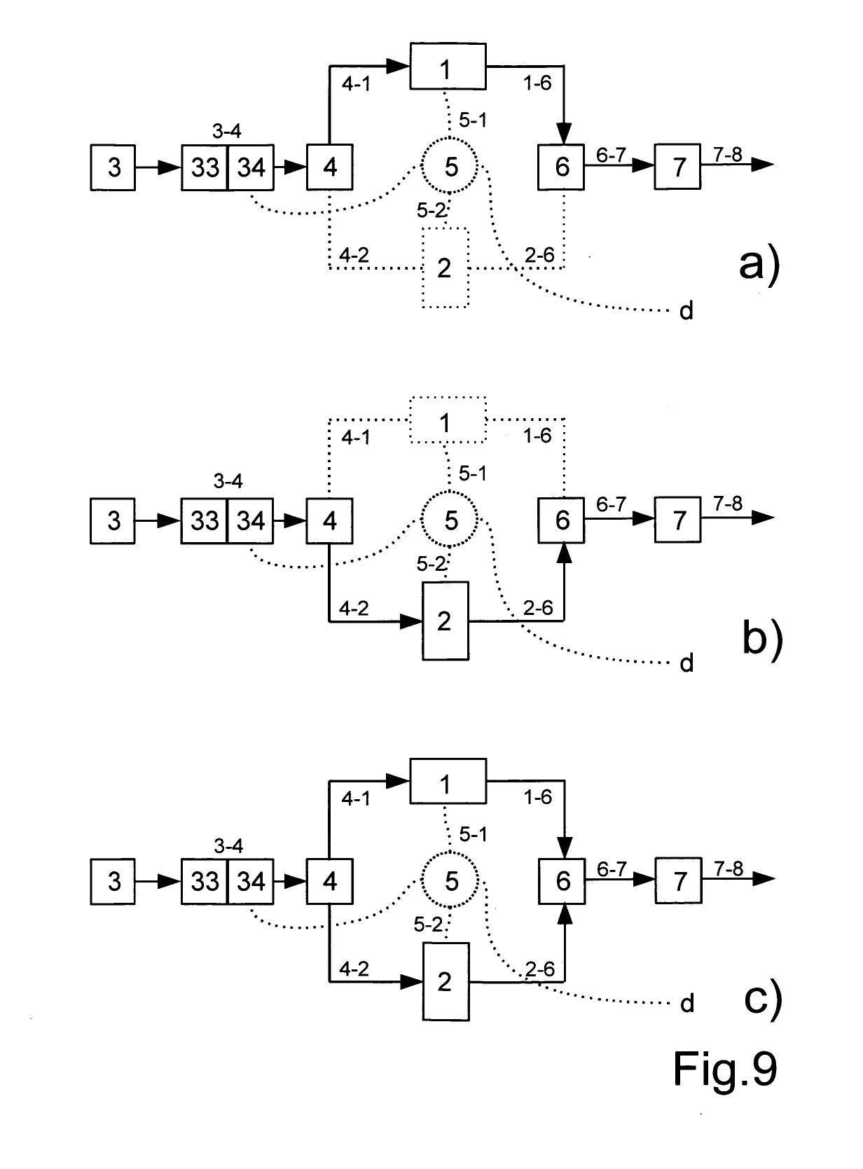

FIG. 9a schematically shows a projection system with two discrete format channels with the switchable polarization conversion system of FIG. 8a with the landscape format channel illuminated.

FIG. 9b schematically shows a projection system with two discrete format channels with the switchable polarization conversion system of FIG. 8a with the portrait format channel illuminated.

FIG. 9c schematically shows a projection system with two discrete format channels with the switchable polarization conversion system of FIG. 8a with the both channels illuminated.

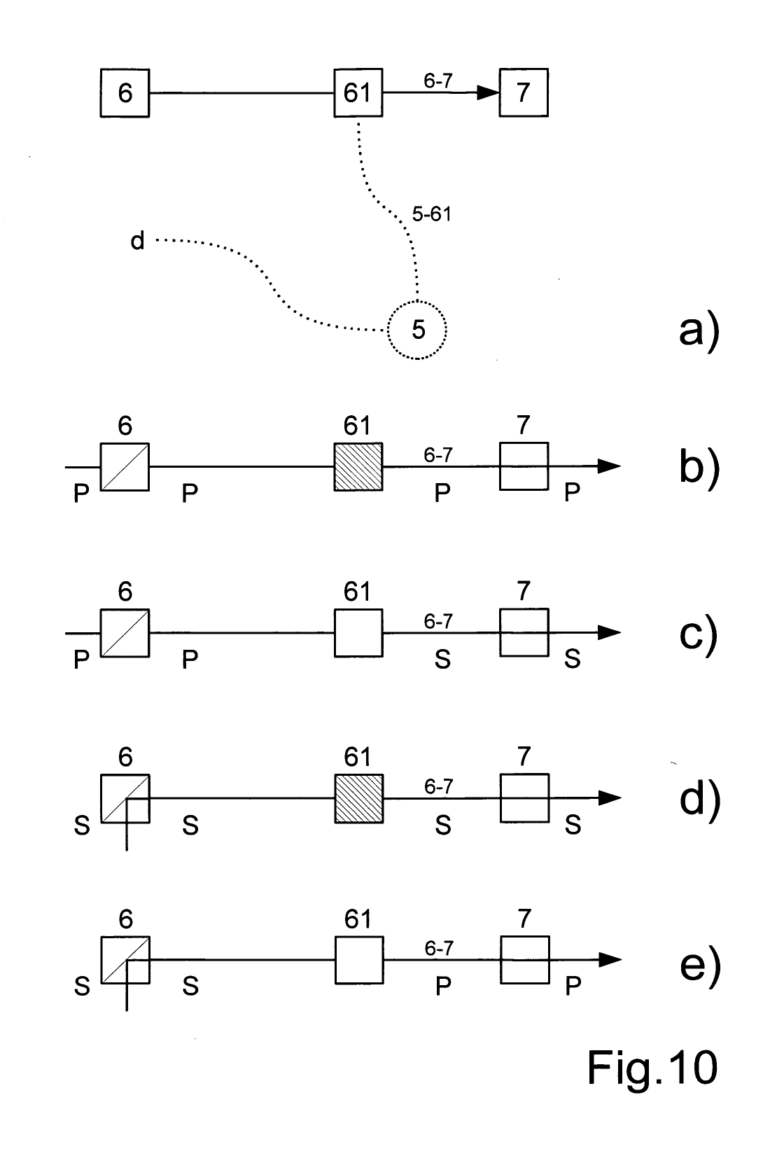

FIG. 10a shows a polarization switcher (61) downstream of the format combining layer (6) in the common output path.

FIG. 10b shows shows how the system of FIG. 8a generates a P-polarized beam from a P-polarized channel.

FIG. 10c shows shows how the system of FIG. 8a generates a S-polarized beam from a P-polarized channel.

FIG. 10d shows how the system of FIG. 8a generates a S-polarized beam from a S-polarized channel.

FIG. 10e shows how the system of FIG. 8a generates a P-polarized beam from a S-polarized channel.

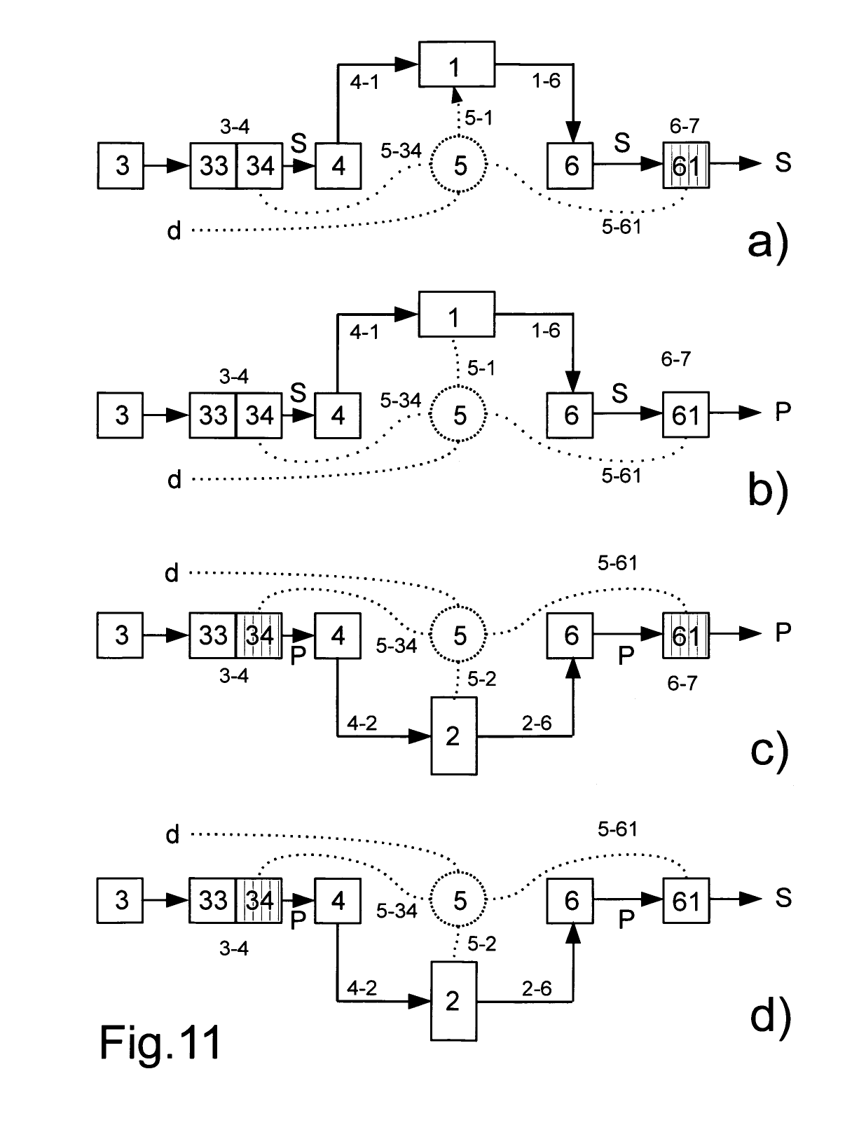

FIG. 11a schematically shows a projection system with two discrete format channels with the switchable polarization conversion system of FIG. 8a and the polarization switcher of FIG. 10a with the landscape format channel illuminated with S-polarized light and outputting S-polarized light.

FIG. 11b schematically shows a projection system with two discrete format channels with the switchable polarization conversion system of FIG. 8a and the polarization switcher of FIG. 10a with the landscape format channel illuminated with S-polarized light and outputting P-polarized light.

FIG. 11c schematically shows a projection system with two discrete format channels with the switchable polarization conversion system of FIG. 8a and the polarization switcher of FIG. 10a with the portrait format channel illuminated with P-polarized light and outputting P-polarized light.

FIG. 11d schematically shows a projection system with two discrete format channels with the switchable polarization conversion system of FIG. 8a and the polarization switcher of FIG. 10a with the portrait format channel illuminated with P-polarized light and outputting S-polarized light.

FIG. 12 shows slide frames as horizontal or vertical frame masks (prior art).

FIG. 13 shows rotatable monitors (prior art).

FIG. 14 schematically shows a 2-channel display system according to the state of the art

### DETAILED DESCRIPTION OF THE DRAWINGS

Reference will now be made to the preferred embodiments of the present invention, examples of which are illustrated in the accompanying drawings.

FIG. 1a is a perspective view onto a image engine according to the invention. As shown therein, the engine comprises a first and a second spatial light modulating system (1,2) and a format combining layer (6), which is a beam splitting layer. The first spatial light modulating system (1) receives light from a light providing system (3), here via a first illumination path (3-1). The modulator of the first modulating system (1) modulates a rectangular pixel array, which has a longer side (A) and a shorter side (B). The modulated beam, the example shows a transmissive modulator, is guided from the first spatial light modulating system (1) to the format combining layer (6) via a first single format path (1-6). Similarly, a second spatial light modulating system (2) receives light from the light providing system (3) via a second illumination path (3-2). As indicated by the drawing, the light providing system (3) might comprise two separate light sources. The modulator of the second modulating system (2) also modulates a rectangular pixel array with a longer side (C) and a shorter side (D). In FIG. 1a the two pixel arrays are, as an example, of the same size. The modulated light of the second spatial light modulator is guided to the format combining layer (6) via a second single format path (2-6). It meets the format combining layer (6) from the other side than (1-6). The format combining layer (6) is arranged to transmit light of one of the paths and to reflect light delivered by the other path into the same direction as the transmitted light, such that a common output path (6-7) is formed. Central to the invention is the relative geometric arrangement of the spatial light modulating systems(1,2) and the format combining layer (6). In the common output path (6-7), the longer side A of the pixel array of the first spatial light modulating system (1) is parallel to the shorter side D of the pixel array of the second spatial light modulating system (2). This is illustrated by the virtual projection A* of the longer side A of the first spatial light modulating system (1) onto the format combining layer (6) along the first single format path (1-6) and the virtual projection D* of the shorter side D of the second spatial light modulating system (2) onto the format combining layer (6) along the second single format path (2-6). Likewise, the virtual projection C* of the longer side C of the second spatial light modulating system (2) onto the format combining layer (6) along the second single format path (2-6) and the virtual projection B* of the shorter side B of the first spatial light modulating system (1) onto the format combining layer (6) along the first single format path (1-6) are parallel. In FIG. 1a, the pixel arrays of the first and the second spatial light modulating systems do not overlap in the common output path (6-7). FIG. 1b shows a variant of the image engine with overlapping pixel arrays in the common output path (6-7). As a further variation, FIG. 1b shows the modulated light of the first spatial light modulating system (1) to be reflected by the format combining layer (6), and the modulated light of the second spatial light modulating system (2) to transmit the format combining layer (6).

FIG. 1c shows a third variant of the image engine with two discrete format channels. As a beam combining layer (6) a polarizing beam splitter (PBS) cube is used. In many preferred aspects of the invention, the absolute alignment of the two formats is such that the longer side of one pixel array in the output path is vertical (ver), to provide a portrait format image, while the longer side of the second pixel array in the output path is horizontally aligned (hor), to provide a landscape format image to the viewer. Additionally to the projection of the pixel arrays onto the format combining layer (6), a second projection is shown on the output face of the PBS cube. In the following figures, with increased geometric complexity, the projection is easier to be shown here than on the format combining layer (6). The parallel relation of A* and D*, and of C* and B* holds on any plane in the output path.

FIG. 2a shows an image engine with two discrete format channels using reflective LC displays as spatial light modulators in a perspective view from slightly below the arrangement. The illumination light comes from above the engine, along the illumination paths (3-1) and (3-2). Before inciding on the modulator(s) of the first spatial light modulating system(1), the illumination light is reflected by polarizing beam splitter (15) via 3-1 onto the modulator(1). According to the 3dimensional arrangement of the figure, the terms “S”- or “P”-polarization relate to the plane of incidence for each splitter. In the example, the polarizing beam splitter (15) might be a StPr-type, which transmits S-polarized light (St), and reflects P-polarized light (Pr). In that case, the plane of polarization of the reflected light would be parallel (P) to the plane of incidence of the reflection at the splitter (15). A an example, this polarizing beam splitter could be a wire-grid polarizer or a cartesian polarizing beam splitter. Accordingly, P-polarized light incides on (1). The modulated On-light is reflected by the reflective LC display of the first spatial light modulating system (1) as S-polarized light. The S-polarized light has its plane of polarization perpendicular (german “Senkrecht”=S) to the plane of incidence of the reflection at the splitter (15). It therefore transmits the StPr-type PBS (15) on the first single format path (1-6). Please note that the format combining layer (6) has a different geometric arrangement and has a different plane of incidence. The polarization of the modulated On-light, which was S-polarized relative to the splitter (15) is P-polarized relative to the plane of incidence of the format combining layer (6), which in this embodiment is also a polarizing beam splitter. The modulated On-light therefore transmits the format combining layer (6), which is a “regular” PtSr type PBS, (like the MacNeille type PBS, which transmits P-polarized light and reflects S-polarized light). Before inciding on the modulator(s) of the second spatial light modulating system (2), the illumination light along path (3-2) is reflected by the polarizing beam splitter (25). This beam splitter is also a PtSr type (like MacNeille PBS). Accordingly, S-polarized light incides on (2). Again, the term “S-polarized” refers to plane of incidence on the splitter (25). The On-light modulated and reflected by the reflective LC display of the second spatial light modulating system (2) is P-polarized light relative to the plane of incidence of the splitter(25) and transmits the PtSr-PBS (25) along the second single format path (2-6). Due to the different geometric arrangement of the format combining layer (6), this light is S-polarized relative to the plane of incidence of this layer (6) and thus it is reflected by it into the common output path (6-7).

FIG. 2b shows a similar embodiment, in which only PtSr-type PBSs are used. In this variant, the reflective display of the first spatial light modulating system (1) is arranged at the bottom of the system. It is illuminated by light transmitting its PBS (15). The On-light reflected and modulated by (1) is S-polarized relative to the splitter (15) and therefore reflected by this splitter. For all other components and polarizations see FIG. 2a.

FIG. 2c shows another variant, in which all reflective modulators (1,2) are positioned in a common plane below the splitters (15, 25). As in FIG. 2a, one of the splitters is of the StPr type. In FIG. 2c this is the splitter (25). In addition to the components already shown in FIGS. 2a,b, the drawing also includes a splitter (4) to split a common illumination beam, placed on top of the system. The light providing system (3) is examplarily shown to consist of three light sources which provide the primary colors red, green, and blue (3R, 3G, 3B). They could be realized by LEDs, lasers or other switchable light sources. The light of the light providing system is split by the illumination splitter (4) into a P-polarized and a S-polarized component. The S-polarized beam is reflected by (4) and guided via the illumination path (4-1) onto the first spatial light modulating system (1). The S-polarized light is folded downward by a mirror or other reflective surface (45). Its transmission at the splitter (15) as P-polarized light and the further processing is described in FIG. 2b. The second illumination component, which is split by the illumination splitter (4) as P-polarized light, transmits the illumination splitter (4) and is guided via the illumination pathway (4-2) onto the second spatial light modulating system (2). It is folded downward by a second mirror or reflection surface (46). This light is S-polarized light relative to the plane of incidence of the splitter (25) and transmits this StPr-type splitter. The reflected light is modulated as P-polarized light relative to the splitter (25) and therefore it is reflected at it, along the second single format path (2-6). Relative to the format combining layer (6) this light acts as S-polarized light and is folded by the combining layer (6) into the common output path (6-7), which is directed onto a projection optics (7).

While FIGS. 2a-c are illustrated with only one modulator in each the first and the second spatial light modulating systems (1,2), systems including 2, 3 or more modulators are easily derived.

FIG. 3a is another embodiment of the image engine with discrete format channels. It is again a perspective view from below the arrangement. It has, like the system shown in FIG. 2c, two modulators positioned in a common base plane. However, in FIG. 3a the modulator types used in the first and second spatial light modulating systems (1,2) are reflective MOEMS. In these MOEMS, modulation is based on the reflection of the modulated beam in an On-direction which is different from the direction of the reflected Off-beam at dark pixels. MOEMS like this have mirror arrays with tiltable mirrors. A first illumination beam incides along the first illumination path (3-1). In the exemplary illustration, the illumination beam transmits a prism (14) with a total internal reflection (TIR) face. The modulated On-beam is reflected from the modulator of the first spatial light modulating system (1) and it is reflected at the total internal reflection face of the TIR-prism (14) along the first single format path (1-6). Likewise, the separation of the illumination beam (along path 3-2) and the modulated beam along the second single format path (2-6) is supported by a second prism with a total internal reflection surface (24). The two single format paths (1-6, 2-6) are combined by the format combining layer (6), which again is shown as a splitter cube. The common output path (6-7) and the projections of the mirror arrays are shown at the output face of the splitter cube with the combining layer (6). Note the special position of the modulators on the cubes. They are rotated by 45. The consequence is reflected by the rotated common output formats, which are not horizontally or vertically relative to the base plane. A position as illustrated is preferred for the use with certain linearly polarized illumination lights. Of course, other positions might be possible, either for polarizing beam splitters, or for other splitters. The system shown as an illustration of the engine is shown with both illumination beams transmitting the TIR-prisms, and both modulated beams being reflected by the TIR-prism. Analogous to FIG. 2b, one spatial light modulating system could also be placed such that its illumination beam would be reflected by its TIR-prism, and that the modulated beam would transmit this TIR-prism. Analogous to FIG. 2a, both spatial light modulating systems could be placed such that their illumination beams would be reflected, and that the modulated beams would transmit their TIR-prisms. An image system using the core of FIG. 3a is shown in the FIGS. 3b-e in a more complete projection arrangement. FIG. 3b is a perspective view on the setup from slightly above the arrangement. The 2-channel image engine with discrete format channels comprises a light providing system (3), a color wheel (31), a beam splitter (4) to direct light via a first and a second illumination path (4-1, 4-2) into the two single format channels and onto the modulators of the first and the second spatial light modulating system (1,2). In addition to the TIR-prisms already described in FIG. 3a, each illumination path includes a mirror (45, 46) and an additional reflection surface (47, 48) to guide the illumination light towards the TIR prism (14, resp.24), before it incides on the spatial modulators of the spatial light modulating systems (1,2). The modulated beams are combined by the format combining layer (6). The modulated output is projected via a projection lens (7). The coordinate system (x,y,z) beneath the perspective view should help to understand the top view shown in FIG. 3c, and the side views shown in FIG. 3d,e. In the top view of FIG. 3c the relative positions of the mirror arrays of the spatial light modulating systems (1,2) are clearly illustrated. Dotted lines indicate objects or paths inside or below other objects. Small circles indicate positions where the beams resp. optical paths change their direction in the component perpendicular to the drawing plane, in FIG. 3c this is in the z-component. FIG. 3d shows in a side view parallel to the yz-plane details of the illumination pathway from the beam splitter (hidden behind the mirror 45). Small circles indicate where the optical paths change the x-component of their direction. The reflection surface (47, exemplarily realized as an internal reflection surface) deflects the path to incide on the modulator of the first spatial light modulating system (1). This reflection site could be realized by any mirror. The modulated beam is reflected in the first single format path (1-6) by the first spatial light modulating system (1). At the total internal reflection surface of the TIR-prism (14) this path is again reflected towards the format combining layer (6). The modulated light transmits this layer (6) into the common output beam (6-7). The projection optics (7) are omitted in this side view. FIG. 3e shows in a side view parallel to the xz-plane details of the illumination pathway from the beam splitter (hidden behind the mirror 46) to the second spatial modulating system (2). The small circles indicate where the optic paths change the y-component of their direction. The reflection surface (48, exemplarily realized as an internal reflection surface) deflects the path to incide on the modulator of the second spatial light modulating system (2). This reflection site could be realized by any mirror. The modulated beam is reflected into the second single format path (2-6) by the second spatial light modulating system (2). At the total internal reflection surface of the TIR-prism (24) this path is again reflected towards the format combining layer (6). The modulated light is reflected by this layer (6) into the common output beam (6-7). The color wheel (31) and the light providing system (3) are omitted in this side view.

Many variations of the illustrated system become immediately obvious. E.g., the illumination paths could used other TIR-prisms, where the the incident light is reflected and the modulated light transmits the prims. Also, if the angle between the incident beam and the modulated beam is chosen sufficiently large, TIR-prisms could be omitted. Also, the sequential illumination could be achieved with other means than a color wheel.

FIGS. 4a-e show another embodiment of the image engine with two discrete format channels and reflective MOEMS. In contrast to the embodiment shown in FIGS. 3a-e no total internal reflection faces and—accordingly—no glass prisms need be used in the engine. FIG. 4a ist a top view on the system, onto the xy-plane (z pointing towards the viewer). It comprises exemplarily a light providing system (3) with two sight sources, two MOEMS modulators in the spatial light modulating systems (1,2) a wire grid polarizing beam combiner as format combining layer (6). None of the optic paths is parallel to the drawing plane, therefore we provide all 4 side views (FIG. 4b-e) of the system to improve the readability of this illustration. Their orientation is given not only by the coordinates of the x,y,z-coordinate system but also in the dot-dash lines of FIG. 4a marked with the letters of the subfigures. As an important difference to the systems of FIG. 3, the modulated On-beams are not reflected in the normal of the MOEMS, but point slightly upward relative to the arrangement. This is easily recognized in FIGS. 4c,d for the beams transmitting the format combining layer (6) into the output path (6-7). In FIG. 4b a side view into the common output beam (6-7) is shown. The vertically arranged modulator (2) is seen from the side. The second single format path (2-6) guides the modulated light slightly upward to the format combining layer (6), where it is folded into the direction to the viewer (circles). The horizontally arranged modulator (1) is hidden (dotted lines) behind the format combining layer (6). In FIG. 4c a side view shows paths 1-6, 6-7 to be oriented slightly upward. In this view, the second modulator (2) is hidden (dotted lines) behind the format combining layer (6). In FIG. 4d the vertically aligned modulator (2) is seen from behind; it stands in front of the format combining layer (6). The horizontally aligned modulator (1) is seen from the side. Finally, in FIG. 4e the horizontally aligned modulator (1) is seen from behind; it stands in front of the format combining layer (6). The common output path (6-7) points away from the viewer.

FIGS. 5a,b show exemplary embodiments in which colors are not sequentially, but simultaneously modulated by several spatial light modulators. In the examples, the spatial light modulating systems (1,2) each comprise 3 transmissive modulators dedicated to modulate single primary colors. In the example, Red, Green and Blue are used. Of course, another set of colors or a different type of modulators could be used according to our invention. In FIGS. 4a,b the modulators of the spatial light modulating systems (1,2) are designated as 1R, 1G, 1B or 2R, 2G, 2B. The modulators of the first and of the second spatial light modulating system (1,2) are situated at the input faces of so-called color cubes (35, 36), which comprise two crossed dichroic layers, which reflect red or blue and transmit green light. FIGS. 5a,b are perspective views from slightly above the engine arrangements. In the engine illustrated in FIG. 5a, the first spatial light modulating systems comprises a color cube (35), with three modulators (1R, 1G, 1B) in an horizontal position, relative to the arrangement. In the example, the modulators receive spectrally different illumination light (3R, 3G, 3B). A color superposition image in a horizontal format is then guided to the format combining layer (6), where it is reflected into the common output path (6-7). The second spatial light modulating system (2) comprises also a color cube (36) with three modulators (2R, 2G, 2B), in an vertical position, relative to the arrangement. In the example, they receive a spectrally different illumination (3R*, 3G*, 3B*). The three vertically aligned modulators form a vertical color image. This is guided to the format combining layer (6) and transmitted (6) into the common output path (6-7). Note that in FIG. 5a the two color cubes stand both in an upright position. Internal optic paths are omitted.

FIG. 5b illustrates a variant of this embodiment, in which the same spectra are used to illuminate the modulators (1R, 2R, 1G, 2G, 1B, 2B) of the spatial light modulating systems (1,2). Another difference of FIG. 5a and 5b is the arrangement of the color cubes. In FIG. 4b, one color cube (35) stands upright, while the second (36) lies horizontally in the arrangement. This may have profound advantages. First, a geometric advantage is given by the fact that the first and the second spatial light modulating systems (1,2) might have the same set of components, which are identically arranged. Second, e.g. if used with a polarizing beam splitter as the format combiner (6), this variant is preferable because two “SSS”—type color cubes might be used. Due to the rotation of the second spatial light modulating system (2) relative to the arrangement of the engine, the S-polarized color image of the second system is P-polarized for the format combining layer (6). Again, FIG. 5a,b are only exemplary illustrations of myriads of arrangements with several spatial modulators in both spatial light modulating systems.

The following figures illustrate operation modes of the engines and introduce optional elements for the image engine with two discrete formats.

FIGS. 6a-c exemplarily illustrate an embodiment of the 2-channel image engine with discrete format channels in three operation modes. Beyond the already described components of the the engine, the FIGS. 6a-c also includes a control logic (5), and the projected image(s) in an image plane (8). FIG. 6a exemplifies a mode, where a monoscopic landscape format image (d) is to be projected by the engine. The control logic gets the image information to be displayed. It has a control line (5-1) to the modulators of the first spatial light modulating system (1) and a second control line (5-2) to the modulators of the second spatial light modulating system (2). The light providing system (3) in this embodiment is by example realized by two independent light sources. If switchable light sources are used, the control logic (5) might even control the light sources via control lines (5-3). Moreover, it is conceivable that the characteristics of the light outputs are matched to the characteristics of the format combining layer (6). In FIG. 6a, the control logic (5) detects a landscape format image in the data (d), and enables only the part of the light providing system (3), which provides light to the landscape channel. Therefore, light is fed only into the first illumination path (3-1). Furthermore, the image information is only fed to the landscape format modulating system (1). The modulated light is directed into the common output by the format combining layer (6). The projection optics (7) project the pixel array of the first spatial light modulating system(1) as a landscape format image (81) into the image plane (8). If the light sources are individually switchable as shown in the example, a high energy efficiency is reached. Also, there is no ghosting in the image, because the portrait format image channel receives no light.

In FIG. 6b, the control logic (5) detects a monoscopic portrait format image in the data (d), and enables only the part of the light providing system (3) which provides light to the portrait channel. Therefore, light is fed only into the second illumination path (3-2). Furthermore, the control logic (5) feeds the image information only to the portrait format modulating system (2). The modulated light is directed via the second single format path (2-6) onto the format combining layer (6), which guides this light into the common output path (6-7). The projection optics (7) project the pixel array of the second spatial light modulating system(2) as a portrait format image (81) into the image plane (8).

In FIG. 6c, a third, optional mode of operation for the 2-channel engine with discrete format channels is shown. The control logic (5) detects a pair of images in the input data (d). This could be either stereoscopic image pairs, or monoscopic images. The control (5) enables the complete light providing system (3) which therefore provides light to both channels. The control (5) then feeds the information to the first and the second modulating systems (1,2). The modulated light is directed into the common output by the format combining layer (6). The projection optics (7) project the pixel arrays of the first and the second spatial light modulating system(1, 2) into the image plane (8).

This is the most complex mode of the three modes shown. It is a perfect mode for stereoscopic image pairs in the quadratic overlapping image area. The mode could also be used to show one monoscopic picture, in all modulated parts of the common output.

FIGS. 7a-c show three possible operation modes in a variant of the image engine shown in FIGS. 6a-c. Instead of separate light sources, the engine uses a light providing system (3) which provides light to both channels. A beam splitter (4) splits the light and guides it into the two channels, via two illumination paths (4-1, 4-2), which connect the splitter and the two modulating systems. Some examples of this have been shown in FIGS. 2c, 3b-e. In FIG. 6a, the control logic (5) reads monoscopic landscape format image information in the input data (d). The control logic (5) sets the second spatial light modulating system (2), here dedicated to the portrait format channel, to the Off-state. The image information is modulated by the spatial light modulating system (1). The further processing is explained in FIG. 6a. In this example, preferred for certain light sources, half of the light provided by the system is not used for the output image in the operation mode shown. Likewise, in FIG. 7b portrait format image information is read by the control logic (5), which sets the first spatial light modulating system (1) to the Off-state. The image information is modulated by the second spatial light modulating system (2). In FIG. 6c a third, optional, mode of operation of the 2-channel image engine is shown. The control (5) feeds the information to the first and the second modulating systems (1,2). The modulated light is directed into the common output by the format combining layer (6). The projection optics (7) project the pixel arrays of the first and the second spatial light modulating system (1,2) into the image plane (8).

As stated above in FIGS. 7a,b, the monoscopic portrait format and landscape format modes might waste some light of the light providing system, especially if only non-switchable light sources are used to provide both channels with light. It might therefore be useful to integrate a converter in the illumination pathway, which converts the light so that only one channel is fed, depending on the input data. As an example, if the beam splitter (4) is a polarizing beam splitter, a switchable polarization conversion system (SPCS) in the illumination pathways could be integrated. FIG. 8a shows an exemplary realization of such a polarization conversion switcher. Here it consists of two components, a prepolarizer (33) and a switchable polarization retarder (switcher, 34), which are integrated in the 2-channel image engine with discrete format channels between the light providing system and the splitter. The switcher might be controlled by the control logic (5), via a control line (5-34). The switcher might be a simple switcher with only two states, e.g. an electronically switchable achromatic retarder. It could also be a complex switcher with a third state, as is illustrated in FIG. 8d.

A first mode of operation of the SPCS is shown in FIG. 8b. The light providing system in this example provides unpolarized light (S+P). The prepolarizer (33) in this example outputs only S-polarized light. In the simplest but wasteful case, it could be a cleanup polarizer, which just uses the S-component comprised in the unpolarized light. The prepolarizer (33) could also be a true polarization conversion system which converts much of the P-polarized component to S-polarized light to increase the efficiency of the system. In the first mode of operation of the SPCS, the switcher (34) is inactive. S-polarized light passes the switcher and the beam splitter (4) directs all the S-polarized light into one illumination path. Here, the first illumination path (4-1) is fed.

In FIG. 8c, the switcher (34) acts like a half-wave retarder. The switcher therefore rotates the plane of polarization of the light by a full 90°. S-polarized input light at the input of the switcher is therefore rotated to P-polarized light. The polarization beam splitter (4) guides this P-polarized light into a different direction than S-polarized light. Here, the second illumination path (4-2) is fed. The inclusion of such a switchable conversion system might greatly improve the light efficacy in the monoscope modes. If, besides the monoscopic landscape format and portrait format outputs also a stereoscopic mode has to be achieved, the SPCS should master also a third state, shown in FIG. 8d. Here, the switcher (34) acts like a quarter-wave retarder. S-polarized light at the input of the retarder is therefore switched to circularly polarized light. The circularly polarized light is split by the beam splitter (4). The third state of the switcher might also rotate the plane of polarization by 45°, which would also lead to the pursued aim that both the first and the second illumination pathway (4-1, 4-2) are fed.

FIGS. 9a-c show three modes of operation of an embodiment of the 2-channel image engine with discrete format channels which includes the SPCS shown in FIG. 8. It can be read like FIGS. 7a-c. However, in the monoscopic modes shown in FIG. 9a,b, most of the available light generated by the light providing system is fed into just one format channel, such that the first spatial light modulating system (1, in the example in the landscape channel) receives in FIG. 9a more light via the illumination path (4-1) than in FIG. 7b, while the second spatial light modulating system (2, in the example in the portrait channel) receives virtually no light via the illumination path (4-2). Without the SPCS, (see FIG. 7a), it receives approximately half of the available light. The SPCS does not only increase the light efficacy of the system, but also improves the image quality by removing the last light remnants of the second channel (in its Off-state), and it also helps to decrease thermal load on the unused modulators.

FIGS. 10a-e show a second optional component for the 2-channel image engine with discrete format channels. It is a simple polarization switcher (61). FIG. 10a shows the polarization switcher (61) integrated in the output path (6-7) between the format combining layer (6) and the projection optics (7). It is controlled by the control logic (5) via a control line (5-61). In the example shown in FIG. 10 only two states, an inactive state (see FIGS. 10b,d) and a active state (FIGS. 10c,e) are necessary. FIG. 10b shows the inactive state in operation. The system provides a modulated image with P-polarized light in the output. The polarization switcher (61) is inactive and therefore P-polarized light is projected via the projection optics (7). In FIG. 10c, the same P-polarized modulated light is provided. The polarization switcher is active and rotates the plane of polarization to output S-polarized light. The switcher is therefore able to switch the polarization of a given channel (lets say the landscape format channel). The same situations are shown for S-polarized input in FIGS. 10d,e. S-polarized input light, lets say modulated in the portrait format channel, is projected as output light if the switcher (61) is inactive (FIG. 10d). If the switcher is active (FIG. 10e), the light modulated as S-polarized light is projected as P-polarized light. The same polarization switcher is therefore suited to switch the polarization of the landscape and of the portrait channel. A 2-channel image engine with a polarization switcher which is arranged downstream to modulation can thus be used to provide sequential stereo projection both of landscape formatted images, and for portrait-formatted images. Moreover, the system does not require active shutter glasses. Inexpensive glasses with passive polarization filters can be used.

In FIGS. 11a-d, four modes of operation are shown in an embodiment of the invention using both the premodulatory SPCS of FIG. 7a and the postmodulatory polarization switcher of FIG. 10a. In FIG. 11a the control logic (5) processes image data to be displayed as S-polarized light. The SPCS composed of the prepolarizer (33) and the switcher (34) generate S-Polarized light in the illumination channel (3-4). The S-light is guided to the first spatial light modulating system (1) via the first format illumination path (4-1) by the beam splitter (4). The modulated light passes the format combining layer (6), here in the example again as S-polarized light. Accordingly, in this example a modulator is used, which does not change the polarization of the light it modulates. Of course, polarization rotating systems (e.g., certain LC-displays) could also be used according to the invention. In FIG. 11a, the switcher (61) is inactive, and the light is projected with unchanged polarization (here as S-polarized light). The second spatial light modulating channel (2) does not receive light here—it is therefore omitted from the drawing. In FIG. 11b, the control logic (5) processes image data (d) to be displayed as P-polarized light. As in FIG. 11a, the SPCS (33/34) generates S-polarized light in the illumination channel (3-4), which is guided to the first spatial light modulating system (1) via the first format illumination path (4-1) by the beam splitter (4). Again, the modulated light passes the format combining layer (6), here in the example again as S-polarized light. Now, the control logic activates the switcher (61) to rotate the polarization to output P-polarized light. Thus, the first format channel can output either P-polarized or S-polarized light, dependent on the control (5). The same is shown for the second format channel in FIGS. 11c,d. If the premodulatory polarization switcher (34) is controlled adequately (compare FIG. 8c), the illumination system produces P-polarized light. The P-polarized light in the example is directed onto the second spatial light modulating system (2) by the beam splitter (4). The spatial light modulating system (2, in the example the portrait format channel) modulates the image information (d) relayed by the control logic (5). In FIG. 11c, resulting P-polarized light passes the inactive switcher (61), and is projected as a P-polarized image. In FIG. 11d, the switcher (61) is active and rotates the plane of polarization such that the modulated image is now projected as S-polarized light. The 2-channel image engine with two discrete format channels which comprises a polarization switcher (61) might therefore generate S and P-polarized images, both in the landscape and in the portrait format. It is excellently suited for sequential stereo. In contrast to many so called stereo ready projectors, which show alternatively left and right images without a coding, the disclosed image system always has a coding for the left and the right channel, be it polarization, color or other. Therefore inexpensive passive, e.g. polarization, goggles can be used to see stereoscopic images. The monoscopic images in the formats, whether they are polarization-, color-, or other-coded, can always be watched with the naked eye-without any glasses.

FIG. 12 shows slide frames, which is prior art. A quadratic illumination is either shaped to a landscape (left side) or to a portrait format (right side) by rotating the same frame by 90 degrees. A part of the image is blocked by the frame mask.

FIG. 13 shows an alternative approach to format choice in PC-monitors according to the state of the art. A rectangular monitor is mounted such that it can be pivoted by 90° to deliver either a landscape or a portrait format image.

FIG. 14 shows the schematic outline of 2-channel systems with a combining layer according to the state of the art. All dual channel systems in the state of the art strive to reach the best possible overlap of the image arrays in a combining layer.

Although the present invention is described by way of detailed embodiments, the presented realizations described in text and drawings serve as illustrations of the invention and not as limitations of the invention. Various other alternations and modifications will become apparent to those skilled in the art after reading the above disclosure. Accordingly, it is intended that the scope and true spirit of the invention is defined by the following claims:

1) Image engine with two discrete format channels, comprising
a light providing system (3);
a first spatial light modulating system (1) with a rectangular pixel array with a longer side A and a shorter side B;
a second spatial light modulating system (2) with a rectangular pixel array with a longer side C and a shorter side D ;
a format combining layer (6);
a light guidance comprising
a first illumination path configured to guide light from the light providing system (3) to the first spatial light modulating system (1);
a second illumination path configured to guide light from the light providing system (3) to the second spatial light modulating system (2);
a first single format path (1-6) configured to guide the light modulated by the first spatial light modulating system (1) onto the format combining layer (6);
a second single format path (2-6) configured to guide the light modulated by the second spatial light modulating system (2) onto the format combining layer (6);
a common output path (6-7) configured to guide the light modulated by one of the spatial light modulating systems which is reflected by the format combining layer (6) and the light modulated by the other spatial light modulating system which transmits the format combining layer (6);
an arrangement of the spatial light modulating systems (1,2), the single format paths (1-6, 2-6) and the format combining layer (6) such that
the virtual projection A* of the longer side A of the pixel array of the first spatial modulating system (1) along the first single format path (1-6) onto the format combining layer (6) is parallel to the virtual projection D* of the shorter side D of the pixel array of the second spatial modulating system (2) along the second single format path (2-6) onto the format combining layer (6);
the virtual projection B* of the shorter side B of the pixel array of the first spatial modulating system (1) along the first format path (1-6) on the format combining layer (6) is parallel to the virtual projection C* of the longer side C of the pixel array of the second spatial modulating system (2) along the second format path (2-6) onto the format combining layer (6).

2) Image engine with two discrete format channels according to claim 1, comprising at least 2 reflective spatial light modulators.

3) Image engine with two discrete format channels according to claim 2, comprising at least 2 reflective surfaces.

4) Image engine with two discrete format channels according to claim 3, wherein each reflective surface is configured to transmit light illuminating a reflective spatial light modulator and to reflect the modulated light beam reflected from this modulator.

5) Image engine with two discrete format channels according to claim 3, wherein each reflective surface is configured to reflect light illuminating a reflective spatial light modulator and to transmit the modulated light reflected from this modulator.

6) Image engine with two discrete format channels according to claim 3, wherein one reflective surface is configured to transmit light illuminating a spatial light modulator and to reflect the modulated light beam reflected from this modulator, and one reflective surface is configured to reflect light illuminating a reflective spatial light modulator and to transmit the modulated light beam reflected from this modulator.

7) Image engine with two discrete format channels according to claim 3, wherein the reflective surfaces are total internal reflection surfaces (14, 24) and the spatial light modulating systems (1,2) comprise Micro Opto Electro Mechanical Systems (MOEMS).

8) Image engine with two discrete format channels according to claim 3, wherein the format combining layer (6) and the reflective surfaces are polarizing beam splitting layers (15, 25) and the spatial light modulating systems (1,2) comprise polarization rotating displays.

9) Image engine with two discrete format channels according to claim 1, comprising at least two transmissive spatial light modulators.

10) Image engine with two discrete format channels according to claim 1, comprising a polarizing beam splitter (4) configured to guide light with a first polarization to the first spatial light modulating system (1) and to guide light with a second polarization to the second spatial light modulating system (2).

11) Image engine with two discrete format channels according to claim 1, wherein the first and the second spatial light modulating systems have pixel arrays of the same size.

12) Image engine with two discrete format channels according to claim 1, wherein the light modulated by the first and the light modulated by the second spatial modulating system overlap in the common output path.

13) Image engine with two discrete format channels according to claim 1, wherein both the first and the second spatial light modulating system comprise exactly one spatial light modulator each.

14) Image engine with two discrete format channels according to claim 1, wherein both the first and the second spatial light modulating system comprise 3 spatial light modulators.

15) Projection system with two discrete format channels comprising
a light providing system (3);
a first spatial light modulating system (1) with a rectangular pixel array with a longer side A and a shorter side B;
a second spatial light modulating system (2) with a rectangular pixel array with a longer side C and a shorter side D ;
a format combining layer (6);
a light guidance comprising
a first illumination path configured to guide light from the light providing system (3) to the first spatial light modulating system (1);
a second illumination path configured to guide light from the light providing system (3) to the second spatial light modulating system (2);
a first single format path (1-6) configured to guide the light modulated by the first spatial light modulating system (1) onto the format combining layer (6);
a second single format path (2-6) configured to guide the light modulated by the second spatial light modulating system (2) onto the format combining layer (6);
a common output path (6-7) configured to guide the light modulated by one of the spatial light modulating systems which is reflected by the format combining layer (6) and the light modulated by the other spatial light modulating system which transmits the format combining layer (6);
an arrangement of the spatial light modulating systems (1,2), the single format paths (1-6, 2-6) and the format combining layer (6) such that
the virtual projection A* of the longer side A of the pixel array of the first spatial modulating system (1) along the first single format path (1-6) onto the format combining layer (6) is parallel to the virtual projection D* of the shorter side D of the pixel array of the second spatial modulating system (2) along the second single format path (2-6) onto the format combining layer (6);
the virtual projection B* of the shorter side B of the pixel array of the first spatial modulating system (1) along the first format path (1-6) on the format combining layer (6) is parallel to the virtual projection C* of the longer side C of the pixel array of the second spatial modulating system (2) along the second format path (2-6) onto the format combining layer (6);
a control system (5) configured to read image data (d) to be projected and to control the first and the second spatial light modulating systems (1,2);
projection optics (7).

16) Projection system according to claim 15, wherein the light providing system comprises
a prepolarizing system (33) configured to polarize light;
a polarization switcher (34) configured to receive the polarized light downstream the prepolarizing system (33) and to change the state of polarization of the prepolarized light depending on the control logic (5)
a polarizing beam splitter (4) configured to guide light with a first polarization to the first spatial light modulating system (1) and to guide light with a second polarization to the second spatial light modulating system (2).

17) Projection system according to claim 15, comprising
a polarization switcher (61) configured to switch the polarization of the light in the common output path (6-7).

18) A method using the image engine according to claim 1 to project images.

19) A method according to claim 18 to project monoscopic images.

20) A method according to claim 19 wherein landscape-formatted images are processed by the first spatial light modulating system (1) and portrait-formatted images are processed by the second spatial light modulating system (2).

21) A method according to claim 18 to project stereoscopic images.

22) A method according to claim 21, whereby left-eye and right-eye information being modulated in parallel by the first and the second spatial light modulating systems (1,2).

23) A method according to claim 21, whereby left-eye and right-eye information being modulated sequentially by one of the two spatial light modulating systems (1,2).
